(19) United States
(12) Patent Application Publication
(10) Pub. No.: US 2026/0044676 A1
(43) Pub. Date: Feb. 12, 2026

(54) SYSTEMS AND METHODS FOR IDENTIFYING DOCUMENTS AND REFERENCES

(71) Applicant: 9197-1168 Québec Inc., Montreal (CA)

(72) Inventors: Hélène LABELLE, Saint-Constant (CA); Elyes LAMOUCHI, Montreal (CA); Min CHEN, Brossard (CA); Neil BARRETT, Longueuil (CA); Tat Fai Wilfred YAU, Montreal (CA)

(21) Appl. No.: 19/104,279

(22) PCT Filed: Jun. 16, 2023
(86) PCT No.: PCT/CA2023/050835

§ 371 Date: Feb. 17, 2025

Related U.S. Application Data
(60) Provisional application No. 63/399,103, filed on Aug. 18, 2022.

(51) Int. Cl. G06F 40/295

(52) U.S. Cl. CPC G06F 40/295

(57) ABSTRACT

The present disclosure provides systems and methods for automated analysis of documents within a collection of documents to identify referenced documents, and for verifying whether the referenced documents are contained within the collection. Broadly, the systems and methods disclosed herein are able to identify documents within a collection of documents, to identify referenced documents referred to within a given document, and to determine whether the referenced document(s) is/are contained within the collection of documents or are otherwise available.

### CROSS-REFERENCE TO RELATED APPLICATIONS

The present application claims priority to U.S. Provisional Patent Application No. 63/399,103, filed on Aug. 18, 2022, the entire contents of which is incorporated herein by reference for all purposes.

### TECHNICAL FIELD

The present disclosure relates to automated document analysis, and in particular to identification of documents.

### BACKGROUND

Respective documents within a given collection of documents will often make reference(s) to other documents, which may or may not be contained within the collection of documents. There are several situations where it is important to verify that all documents referenced within a certain collection of documents are contained within the collection of documents or are otherwise available.

One particular example is in mergers and acquisitions (M&A), where during a transaction every document representing an asset being acquired must be transferred, including all interrelated documents listed inside files. A reference to a document can be found anywhere in a document: under a reference section, inside a legal clause, or just mentioned in a sentence, it is important that the acquiring party receives a transfer of all relevant documents. For example, if a document is a Change Control Form A that refers to a Stability Protocol A, then it would be important to ensure that the Stability Protocol A is contained within the transferred documents.

Presently, this process of analyzing documents for any reference documents, and subsequently searching for the reference document in a collection of documents, is a manual process and often results in missing documents, unusable data, and delays in being able to utilize the data within the collection of documents.

Accordingly, systems and methods that enable being able to identify references and to verify the availability of the referenced documents remains highly desirable.

### SUMMARY

In accordance with one aspect of the present disclosure, a method of assessing availability of documents referenced within a collection of documents is disclosed. The method comprises: analyzing the collection of documents to identify a referenced document referred to within a document in the collection of documents; generating a referenced document signature for the referenced document; and determining if the referenced document is available within the collection of documents by comparing a referenced document signature against a set of document signatures associated with the documents within the collection of documents.

According to an example embodiment, the method further comprises: creating the set of document signatures by generating, for each respective document within the collection, at least one unique document signature associated with the respective document. Preferably, the at least one unique document signature associated with the respective document comprises one or more of: file name attributes, a title, and an identifier of the respective document.

According to an example embodiment, generating the at least one unique document signature of the respective document comprises determining the file name attributes using all tokens and numbers from a file name of the respective document.

According to an example embodiment, generating the at least one unique document signature of the respective document comprises determining at least one of the title and the identifier from data within the respective document.

According to an example embodiment, identifying a referenced document referred to within a document in the collection of documents comprises: annotating sentences from the document with linguistic features; extracting noun phrases from said annotated sentences; and applying linguistic based filtering to locate noun phrases comprising the referenced document.

According to an example embodiment, applying linguistic based filtering to locate noun phrases comprising the referenced document comprises applying filters based on one or more of: pattern recognition, syntactic based rules, lexical based rules, dependency based rules, and part-of-speech based rules.

According to an example embodiment, the method further comprises removing unnecessary tokens from noun phrases comprising the referenced document.

According to an example embodiment, the method further comprises separating noun phrases comprising a plurality of referenced documents.

According to an example embodiment, the method further comprises comparing the noun phrases to remove duplicate references.

According to an example embodiment, performing the filtering using the lexical based rules comprises: determining that the noun phrase does not contain a referenced document if the noun phrase comprises less than k keywords, the keywords being representative of words used in a sentence making a reference to a document, wherein k is tunable; and when the located phrase comprises k or more keywords classifying the document referenced in the located sentence as the referenced document.

According to another example embodiment, generating the referenced document signature for the referenced document comprises: generating a set of referenced document signatures, wherein each referenced document signature comprises one or more of: file name attributes, a title, and an identifier of a corresponding referenced document; comparing each generated referenced document signature in the set to identify any duplicate referenced document signatures, wherein two or more referenced document signatures are duplicate if one or more of the file name attributes, the title, and the identifier of the referenced document signatures are essentially identical; and merging the file name attributes, the title, and the identifier from each of the two or more duplicate referenced document signatures to generate a unique referenced document signature of the referenced document.

According to another example embodiment, the method further comprises: converting respective documents in the collection of documents into a standard document having a standard document format, the standard document comprising data of the respective document, and the standard document format containing one or more annotations added to the data.

According to another example embodiment, the method further comprises: comprising classifying the referenced document based on a relevancy measure.

According to another example embodiment, the method further comprises: classifying the referenced document based on a provenance of the referenced document.

According to another example embodiment, the method further comprises generating an output based on a result of: determining if the referenced document is available within the collection of documents; and classifying the referenced document based on the relevancy measure and/or the provenance of the referenced document.

According to another example embodiment, the method further comprises: when it is determined that the referenced document is not available within the collection of documents, generating an output indicating that the referenced document is not available.

According to another example embodiment, the method further comprises: determining if the referenced document is a publicly available document if it is determined that the referenced document is not available within the collection of documents, and generating an output indicating that the referenced document is publicly available.

According to an example embodiment, the method further comprises generating an output based on a result of determining if the referenced document is available within the collection of documents.

According to another example embodiment, the method further comprises: identifying a plurality of referenced documents within the collection of documents.

According to an example embodiment, identifying the referenced document comprises identifying the referenced document in at least one of an in-section reference or an in-text reference. Preferably, identifying the referenced document in the in-section reference comprises: performing section detection to identify sections within the document; determining if an identified section is a relevant reference section; and when the identified section is determined to be the relevant reference section, identifying the referenced document from the identified section.

According to an example embodiment, identifying the referenced document in the in-text reference comprises using pattern matching regular expressions to identify the referenced document within document data, and/or identifying text relations and/or any aspect of the grammar of a sentence to identify the referenced document within the text relations. Preferably, identifying the referenced document comprises: identifying a sentence potentially referring to a document; and performing filtering to determine if the sentence references the document.

According to another example embodiment, performing the filtering comprises: creating one or more triples from the located sentence comprising a predicate of the located sentence and at least one argument of the located sentence, the at least one argument being any expression or syntactic element in the located sentence that serves to complete a meaning of the verb; comparing the predicate of the triple with one or more normalized golden relations; when the predicate matches one or more normalized golden relations: extracting one or more arguments of the predicate; and classifying the document referenced to in the one or more arguments of the predicate as the referenced document; when the predicate does not match one or more normalized golden relations, determining that the located sentence does not contain the referenced document.

According to another example embodiment, comparing the predicate of the triple with one or more normalized golden relations comprises: normalizing the predicate by associating each token of the predicate with its lexical lemma; removing low inverse document frequency tokens from the predicate; and comparing the predicate with the one or more normalized golden relations, and determining that the predicate matches with one or more normalized golden relations if a threshold match measure is reached.

According to another example embodiment, performing the filtering comprises using a binary classifier that is configured to: tokenize the located sentence; filter out the located sentence based on a selectivity measure that takes into account token frequency and inverse token document frequency; and when the selectivity measure is satisfied, classifying the document referenced in the located sentence as the referenced document.

In accordance with one aspect of the present disclosure, the invention is directed to a method of identifying a referenced document within a document, comprising: locating a sentence potentially referring to a document; and performing filtering to determine if the sentence references the document.

In accordance with another aspect of the present disclosure, a method of identifying a document is disclosed, comprising: determining file name attributes using tokens and numbers from a file name of the document; determining a title of the document; searching for an identifier identifying the document; and generating a unique document signature associated with the document, wherein the at least one unique document signature comprises one or more of the file name attributes, the title, and the identifier of the respective document.

In accordance with another aspect of the present disclosure, a system for assessing availability of documents referenced within a collection of documents is disclosed, the system comprising: a processor; and a non-transitory computer-readable memory storing computer-executable instructions, which when executed by the processor, configure the system to perform the method of any one of the aspects and example embodiments above.

In accordance with one aspect of the present disclosure, the invention is directed to a non-transitory computer-readable memory having computer-executable instructions stored thereon, which when executed by a processor, configure the processor to perform the method of any one of the aspects and example embodiments above.

### BRIEF DESCRIPTION OF THE DRAWINGS

Further features and advantages of the present disclosure will become apparent from the following detailed description, taken in combination with the appended drawings, in which:

FIG. 1 shows a representation of a system for assessing availability of documents referenced within a collection of documents;

FIG. 2 shows a representation of a method of assessing availability of documents referenced within a collection of documents;

FIG. 3 shows a method of assessing availability of documents referenced within a collection of documents;

FIG. 4 shows a method of creating a set of document signatures for a collection of documents;

FIG. 5 shows a method of identifying a title in a document;

FIG. 6 shows a representation of document signatures;

FIG. 7 shows a representation of a set of document signatures;

FIG. 8 shows a method of identifying a referenced document within a document;

FIG. 9 shows an architecture for identifying a referenced document within a document;

FIG. 10 shows a method of classifying a document;

FIG. 11 shows a representation of comparing referenced document signatures against the set of document signatures.

FIG. 12 shows a further method of identifying a referenced document within a document;

FIG. 13 shows a further method of identifying a referenced document in sentences;

FIG. 14 shows a further method of identifying a referenced document;

FIG. 15 shows a method for comparing the predicate of the triple with one or more normalized golden relations; and

FIG. 16 shows a further method of identifying the referenced document.

It will be noted that throughout the appended drawings, like features are identified by like reference numerals.

### DETAILED DESCRIPTION

The present disclosure provides systems and methods for automated analysis of documents within a collection of documents to identify referenced documents, and for verifying whether the referenced documents are contained within the collection. Broadly, the systems and methods disclosed herein are able to identify documents within a collection of documents, to identify referenced documents referred to within a given document, and to determine whether the referenced document(s) is/are contained within the collection of documents or are otherwise available. The automation provided by the systems and methods disclosed herein leads not only to a faster process, but also a better accuracy in identifying any missing documentation.

It will also be understood that the systems and methods disclosed herein may only be used to perform a part of the process. For example, it will be appreciated that the ability to identify documents and to identify referenced documents within a document in an automated manner may be useful in several applications, and the systems and methods may be used to identify documents and/or to identify referenced documents.

Further, while described herein as being applicable to M&A transactions, it would be appreciated that the systems and methods disclosed herein may have various applications, and in particular to any sale of knowledge/research. Further still, while the present disclosure particularly focuses on identifying referenced documents, it would also be appreciated that the systems and methods may be configured for identifying various types of entities/information within a collection of documents. However, as further described herein, identifying referenced documents poses unique challenges because there is not necessarily a standard format of naming/identifying documents.

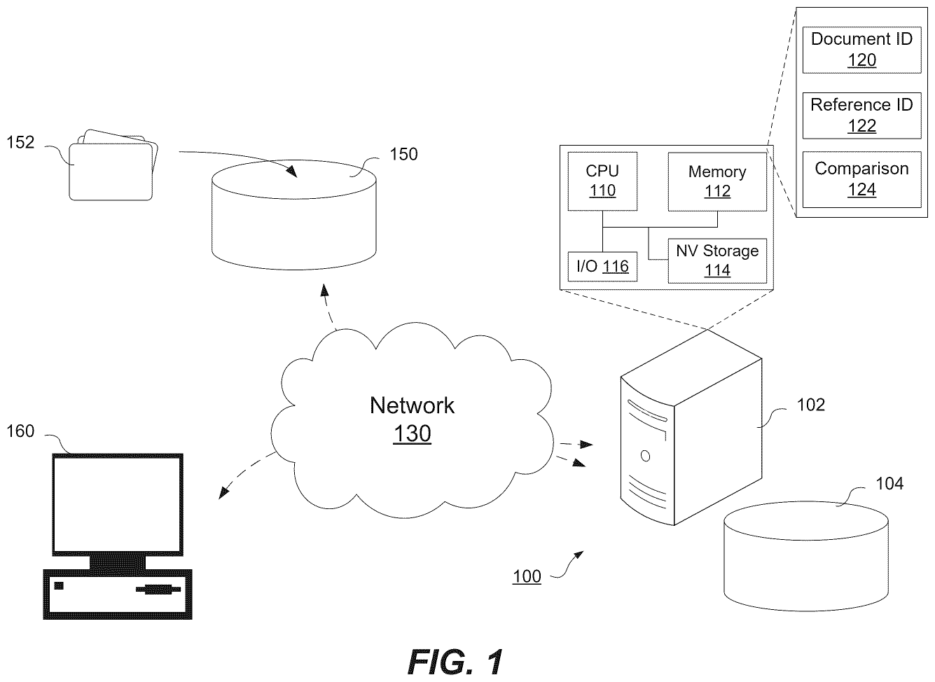

Embodiments are described below, by way of example only, with reference to FIGS. 1-16.

FIG. 1 shows a representation of a system 100 for assessing availability of documents referenced within a collection of documents. The system 100 comprises an application server 102 and may also comprise an associated data storage 104. The application server 102 functionality and data storage 104 can be distributed (cloud service) and provided by multiple units or incorporate functions provided by other services. The application server 102 comprises a processing unit, shown in FIG. 1 as a CPU 110, a non-transitory computer-readable memory 112, non-volatile storage 114, and an input/output (I/O) interface 116. The non-volatile storage 114 comprises computer-executable instructions stored thereon that are loaded into the non-transitory computer-readable memory 112 at runtime. The non-transitory computer-readable memory 112 comprises computer-executable instructions stored thereon at runtime that, when executed by the processing unit, configure the application server 102 to perform certain functionality as described in more detail herein. In particular, the non-transitory computer-readable memory 112 comprises instructions that, when executed by the processing unit, configure the server to perform various aspects of a method for assessing availability of documents referenced within a collection of documents, including code for performing document identification 120, code for performing referenced document identification 122, and code for comparing referenced document signatures against document signatures 124. The I/O interface 116 may comprise a communication interface that allows the application server 102 to communicate over a network 130 and to access the data storage 104. The I/O interface 116 may also allow a back-end user to access the application server 102 and/or data storage 104.

Client documents 152 are provided to the application server 102 as a collection of documents for processing. While most documents may be provided in typical document formats such as .doc or .pdf, it will be appreciated that a document may be a basic unit of information comprising a set of data. In some embodiments the application server 102 may provide a web platform through which client documents 152 are uploaded. The client documents 152 may be compiled in a data storage 150 and uploaded to the platform via network 130. In other embodiments the application server 102 may receive the client documents 152 through other means of document transfer as would be known to those skilled in the art. Further still, the application server 102 may itself access the data storage 150 over the network 130 to retrieve the documents, and/or may query the data storage 150 to determine client documents from the contents of the data storage 150. While the present disclosure particularly discusses analyzing a collection of client documents with respect to identifying referenced documents and determining whether the referenced documents are available within the collection, it would be appreciated that the application server 102 may perform methods on just a single document, e.g. to identify the document, and/or to identify any references contained with the document.

As previously mentioned, the application server 102 is configured to execute methods for assessing the availability of documents referenced within a collection of documents. In general, the application server 102 is configured to analyze the collection of documents to identify referenced documents that are referred to within the collection of documents. The application server 102 is further configured to determine whether the referenced documents are available within the collection of documents. The application server 102 is further configured to generate various types of outputs, which may for example be output to a client computer 160 over the network 130, and the client computer 160 may or may not have provided the client documents 152 (i.e. the client documents 152 may be received from one entity, such as an entity responsible for transferring files to an acquiring party, and the output may be presented to client computer 160 of another entity, such as belonging to the acquiring party). The output may comprise an output displayed in a web platform, a report sent to client computer 160, etc. In some aspects the output may comprise a list of any referenced documents that are missing from the collection of documents. The output may also identify a total number of missing documents, and may sort missing documents based on an importance metric (e.g. based on a number of times the missing referenced document is referred to within the collection of documents, where a missing document that is referred to more times is deemed to be of more importance than a missing document that is referred to only once). The output may also sort the retrieved and/or the missing documents based on a classification of said documents (e.g., internal document, external document, etc.). The methods of assessing availability of documents referenced within a collection of documents are described in more detail below.

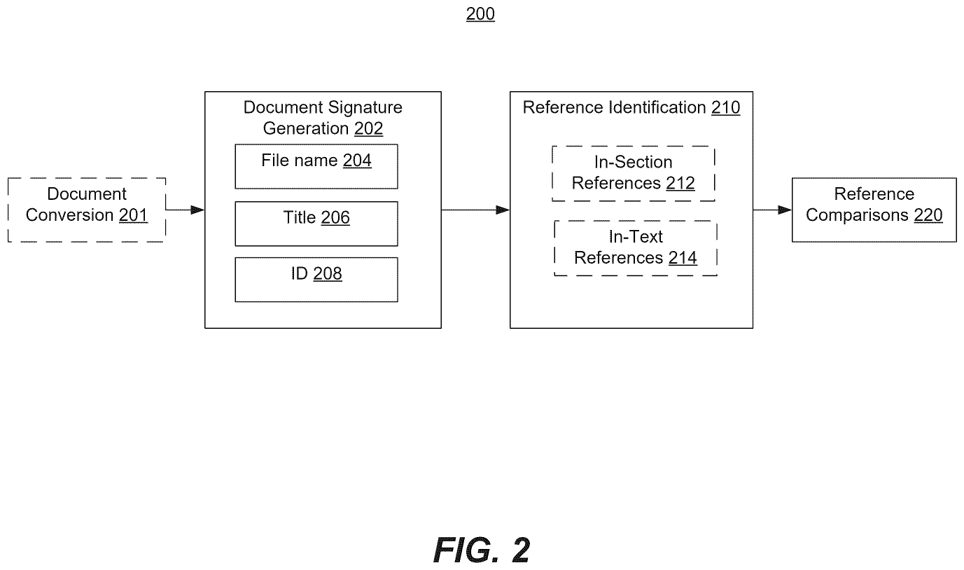

FIG. 2 shows a representation of a method 200 of assessing availability of documents referenced within a collection of documents. The method 200 may be executed by the application server 102 of FIG. 1 in an automated manner without user input. The method 200 comprises three main aspects: document signature generation 202, reference identification 210, and reference comparisons 220. The document signature generation 202 creates a set of document signatures by analyzing each document in the collection of documents and determining one or more of: file name attributes 204, a title 206, and an identifier 208 of the respective document. The reference identification 210 analyzes each document in the collection of documents to identify referenced documents that are referred to within the collection of documents. In some embodiments, the reference identification 210 may comprise executing different methods to identify in-section references 212 and in-text references 214. However, in other embodiments referenced documents can be found anywhere in a document using a single approach comprising linguistic-based filtering. The reference comparisons 220 determines if the referenced documents are available within the collection of documents.

To perform the method 200 in an automated manner, different algorithms may be used for document signature generation 202, reference identification 210, and reference comparisons 220. The algorithms may be written separately for each type of document format, however it will be appreciated that this would require a lot of effort for the numerous different document formats that the client documents may be received in. Accordingly, the method 200 may further comprise an initial document conversion 201, which converts the respective documents in the collection of documents into a standard document having a standard document format, while preserving the data of the respective document. The standard documents may be stored in the data storage 104 of FIG. 1 for example, for subsequent access by the application server 102. The standard document format may for example be JSON, which advantageously contains several useful annotations for the method 200, including linguistic annotations, font-related annotations and section-related annotations. While the present disclosure makes specific reference to converting documents into a JSON file format, it would be appreciated that other standard document formats may be used, and also that multiple AI algorithms could be written for different file formats. An instance of another standard document format that may be used is the OpenOffice document standards (ODF).

Further, as previously noted, it would be appreciated that different aspects of the method 200 are advantageous on their own and may be performed individually and/or independently from other aspects of the method 200. That is, there are applications where it would be advantageous just to identify documents within a collection of documents. In other applications it may be advantageous just to identify referenced documents referred to within a collection of documents. In still other applications, it may be advantageous to identify referenced documents and compare them against a set of known document signatures (i.e. without needing to generate document signatures for the documents within the collection).

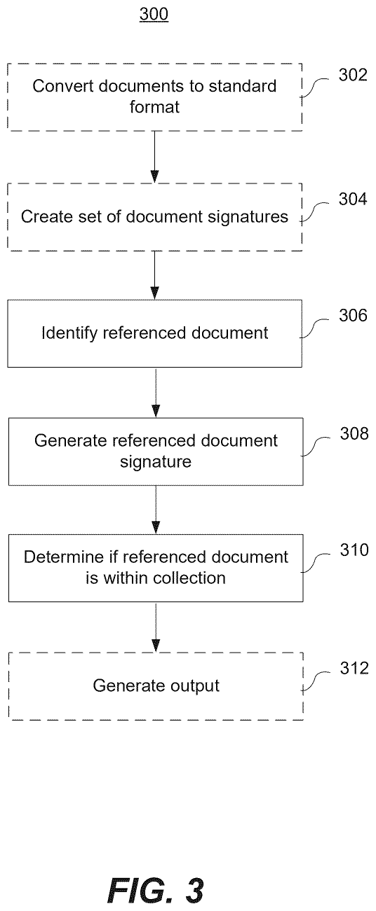

FIG. 3 shows a method 300 of assessing availability of documents referenced within a collection of documents. The method 300 may be performed by the application server 102 of FIG. 1, when executing the instructions stored in the non-transitory computer-readable memory 112.

The method 300 may comprise converting respective documents in the collection of documents into a standard document having a standard document format (302). The standard document comprises data of the respective document, and the standard document format may contain one or more annotations added to the data, which may be useful for identifying documents and for identifying references within the document. It will be appreciated that the method 300 may not require this conversion to a standard document, such as when code is written for multiple different formats, and/or if a document is already in a standard document format.

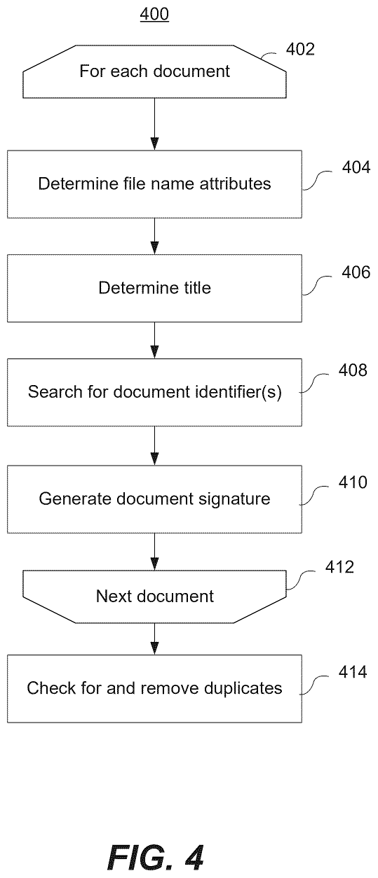

The method 300 may comprise creating a set of document signatures (304). Creating the set of document signatures may be performed by generating, for each respective document within the collection, at least one unique document signature associated with the respective document. The at least one unique document signature may comprise one or more of: file name attributes, a title, and an identifier of the respective document. It will be appreciated that some datasets already comprise unique document signatures that can be looked up for comparing against referenced document signatures, and therefore the method 300 may not require creating the set of document signatures. The method of creating a set of document signatures is described in more detail with respect to FIG. 4.

The method 300 comprises analyzing the collection of documents to identify a referenced document referred to within a document in the collection of documents (306).

A referenced document signature that identifies the referenced document is generated (308) for the referenced document. The referenced document identified within the document can be referred to using various identifiers and may be identifiable using one or more of: file name attributes, a title, and an identifier of the referenced document. A set of referenced document signatures may also be generated, each corresponding to a different referenced document identified within the text. However, some referenced documents may be present more than one time in a collection of documents, and therefore there may be multiple referenced document signatures for the same referenced document. Referenced document signatures in the set are compared to identify any duplicates that share one or more of the file name attributes, the title, and the identifier of the referenced document, and thus identify referenced documents that are essentially identical (within a threshold). Where duplicates are found, the referenced document signatures are merged to generate a unique document signature of the referenced document. It is possible that two different documents may share a same file name or title. It is thus advantageous to generate as much information in a referenced document signature, which could also include secondary information to help further distinguish references. As an example, a project or product identifier may be associated with many documents related to the project or product, and such a project/product identifier may be identified in the document and associated with the referenced document. Accordingly, two documents may refer to a reference having the same title but the documents may be associated with two different project identifiers, and thus the referenced documents can be uniquely identified.

A determination is made if the referenced document is identified within the collection of documents (310). The determination is made by comparing the referenced document signature against a set of document signatures associated with the collection of documents. A threshold may be used to determine if a referenced document signature is deemed close enough to match a given document signature. For example, a referenced document may be spelt incorrectly (“Protocal A” instead of “Protocol A”), or may otherwise not quite be an exact match (e.g. a referenced document may have a document signature “53291”, while the document signature specifies the identifier is “53291.1”). If the referenced document signature meets or exceeds the threshold, it is considered that the referenced document is identified within the collection of documents.

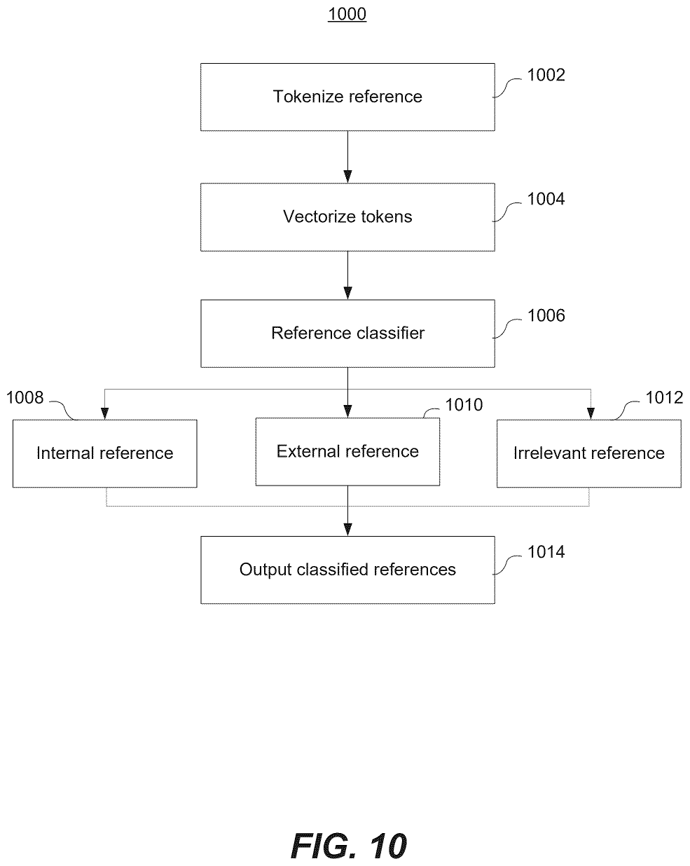

The method 300 may further comprise generating an output (312). As previously described the output may comprise an indication of referenced documents that are not available in the collection of documents. The output may take many forms, and in some aspects may list the missing referenced documents in order of importance based on the number of times that the respective documents were referenced. In a further aspect of the method, when a referenced document is not identified as being within the collection of documents, a determination may be made as to whether the referenced document is a publicly available document. Where the referenced document is publicly available, the output may indicate which referenced documents are publicly available, and may for example provide a link to a webpage having the document. In a further aspect of the method, this identification may be performed for each referenced document without taking into account its availability. A classifier may be used to classify the referenced documents into a plurality of classes. An example of a classifier is described below with respect to FIG. 10.

FIG. 4 shows a method 400 of creating a set of document signatures for a collection of documents. The method 400 is performed for each document in the collection of documents (402).

The method 400 comprises determining file name attributes (404). Determining file name attributes may use one or more tokens (in order) and numbers from the file name. Preferably, all tokens and numbers from the file name are used for determining the file name attributes. Determining file name attributes is important as some documents don't have a title or an ID, and file name attributes may be the only way to retrieve identification information. However, the file attributes may sometimes be useless for providing information for identifying the document, as some file names of documents are irrelevant, being purposeless (e.g., “Monday”, “Run Combo”) or representing the surname of an employee or a place (e.g.: “Guggenheim”).

The method 400 further comprises determining a title of the document (406). In essence, the task of title detection is to correctly locate the title in a particular document. As described above, the document may be converted into a standard document having a standard format such as JSON that contains different fields and metadata. Once the title for a document is determined, the title may also be annotated in the standard document.

There is a plurality of methods to detect titles. Instances of methods to detect titles may include for example image-based methods, text-based methods, etc.

Title detection by image processing is performed from object detection in an image. There are generally two steps in determining the title: (1) object detection to get a rough estimation for a bounding box of the title, and (2) title extraction using an optical character recognition (OCR) engine. Examples of such engines may include tesseract optical character recognition engine, EasyOCR engine, etc. For example, the title detection may be performed using GitLab™ code YOLOv3 (You Only Look Once, Version 3) from Keras. YOLOv3 is a real-time object detection algorithm that identifies specific objects in videos, live feeds, or images. YOLO uses features learned by a deep convolutional neural network (CNN) to detect an object. It applies a single neural network to the full image, and then divides the image into regions and predicts bounding boxes and probabilities for each region.

For text-based methods, to identify a title within a document, characteristics that are common to titles are defined. One example is length: titles are shorter and are seldom longer than a line. A second example is that titles are likely to be non-verbal sentences and in general exhibit a simpler syntactical structure. Other features like those provided with the dataset can be useful: begins with numbers, material aspect (bold/italic), capitalization (begin with capitals, all caps). Accordingly, the following features are useful to identify the title in a document: length of text segment; text size; text font; bold, italic, etc.; text alignment; word block height/spacing between blocks; etc.

For implementing text-based methods, the following characteristics of titles may be used to differentiate titles from other text content in a document:
title has the largest font size in the 1st page;
normally, title is bold;
normally, title is not in footer or header;
title may not be centered (alignment may not be centered);
normally, title is a noun phrase among multiple lines of text contents with the largest size;
the space above and below title is bigger; and
some words in title appear frequently in the content.

A person skilled in the art will appreciate that there are many characteristics common for titles and that defining further characteristics for use in title detection are within the scope of the disclosed invention. Text-based heuristics may be used to identify titles from other text content. Since a JSON file can be a structured representation of any document, e.g., Word and PDF file are most common file types, the standard document may be used to simplify the AI algorithm. Transforming all documents, e.g., Word file or PDF file, into standard documents (JSON files), whose annotation “style_exceptions” is used to capture text-based features, e.g., font information, may be used to detect titles based on the font information. The following JSON snippet shows an example of “style_exception” where “type” and “char_span” locates character span of the text font formation in a document:

```
“style_exceptions”: [
{
  “63056f2286264496a34248ce691b2604”: {
    “font_size”: 14.0,
    “font_type”: “Arial”,
    “font_style”: [
      “bold”
    ],
    “location”: [
      {
        “type”: “text”,
        “char_span”: [
          5557,
          5566
        ]
      },
      .....
      {
        “type”: “table”,
        “table_id”: “40d56c7ecadc4dcd91cd81999e5d3791”,
        “cell”: [
          0,
          0
        ],
        “char_span”: [
          0,
          19
        ]
      },
      ......
  }
    . . . .
}
]
```

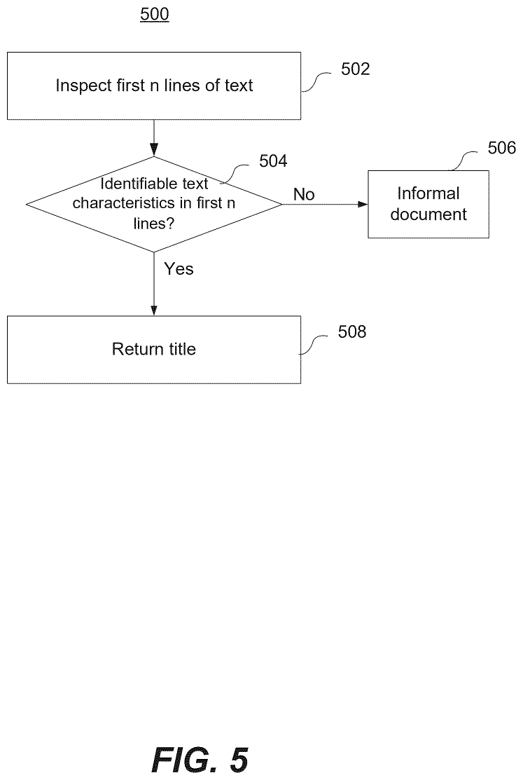

The JSON file format allows adding annotation to documents, which can automatically be applied to help locate titles. An example method of identifying a title in a document is described in more detail with reference to FIG. 5. Further, even if there is insufficient characteristics present to determine the title of a document, title detection may be performed by determining which text is not a title in order to identify the most probable title.

With reference again to FIG. 4, the method 400 further comprises searching for an identifier(s) present within the document (408). The task of searching for identifier(s) involves identifying and extracting identifiers in documents. It will be appreciated that identifiers can come in a variety of types and formats, and may be located in a variety of areas within document. For instance, each company or project may have its own specific set of IDs that conforms to a certain pre-determined format.

On top of that, there could be a wide array of IDs located within a single document: there could be a document ID referring to the document, there could be product and protocol IDs that are used within the same documents to refer to a particular product or protocol, and there could be various other kinds of reference identifiers, such as reference numbers, tracking numbers, etc. The task of ID extraction is therefore two-fold: the identification of identifiers, and the matching of these IDs to their keys (e.g. protocol vs. document IDs).

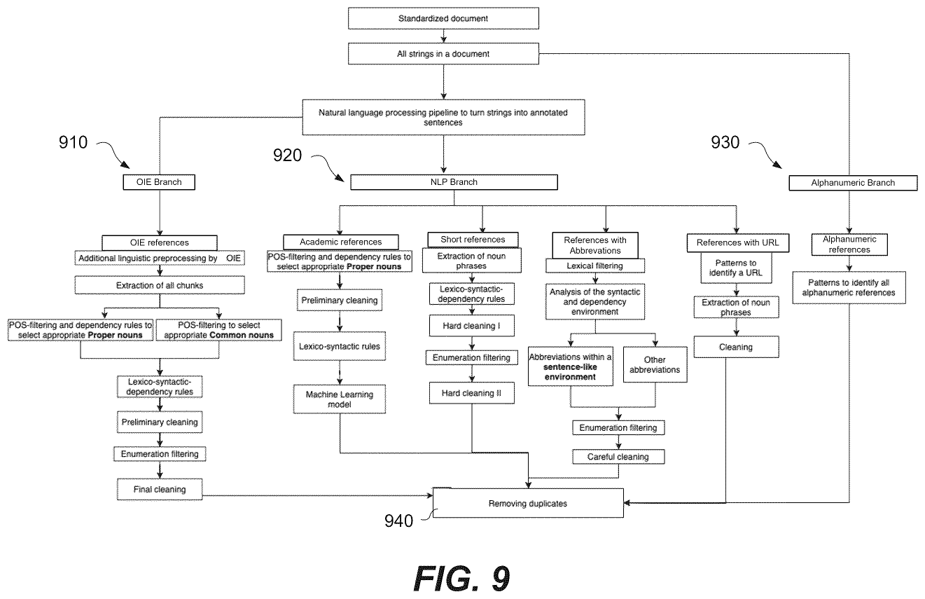

Identifiers can be recovered through image processing techniques such as Optical Character recognition. Another technique for searching for identifiers may include extracting information from the document data (or the standard document data). The identifiers may be identified using pattern matching (e.g., regular expressions that are defined according to common characteristics of identifiers). For example, one common characteristic/pattern of identifiers is that they tend to incorporate the use of hyphens “-”. Accordingly, a regular expression rule that may be applied is to identify text strings that contain hyphens. A person skilled in the art would appreciate that such a characteristic may result in false positives (e.g., the string representation of embedded objects such as tables indicated as “<!emb . . . >”, or words like “ice-cream” or “de-facto”), and therefore the text strings extracted using regular expressions may require to be filtered, e.g. by removing “<!emb- . . . >”, or by removing text strings that contain no numbers (as identifiers typically include at least one number). In some embodiments, an alphanumeric filter, such as the alphanumeric filter described with respect to FIG. 9, may be used to locate the identifiers.

In accordance with the method 400, a document signature is generated (410) that comprises information identifying the document including the file name attributes, the title, and any identifiers that identify the document.

The method 400 is repeated for a next document (412) in the collection of documents. After generating document signatures, the method 400 may comprise parsing the set of document signatures to check for any duplicates, where any duplicates are removed (414). For example, a collection of documents may inadvertently include the same document more than once. Two document signatures that are the same may be identified and merged in the set.

FIG. 5 shows an example method 500 of identifying a title in a document. The method 500 comprises inspecting the first n lines of text at the beginning of the document (502), where “n” is a number greater than or equal to 1, and determining if there are identifiable text characteristics in the first n lines of text (504). The identifiable text characteristics searched for in the first n lines of text may be one or more of the characteristics as discussed above, such as bold or underlined text, larger font, the identification of an alignment change, etc.

As explained above, one characteristic of the title is that it normally lies within the first page of a document. As page breaks are often unavailable in documents, the parameter n may be used as a threshold parameter used to identify the first page.

If there are no identifiable text characteristics in the first n lines (NO at 504), it may be determined that the document is an informal document (506), and the title of the informal document may be taken simply as the first line of text (unless a number is present, possibly representing a date or a page number, in which case the title is the first line of text that contains one or more words). Informal documents may for example include notes taken by someone during a meeting, and are typically less valuable for document transfer. On the other hand, most interrelated documents refer to formal types of documents, which have a clearly defined title, and generally represent an asset for a company.

If there is identifiable text characteristics in the first n lines (YES at 504), the text is determined to represent a title and is returned (508).

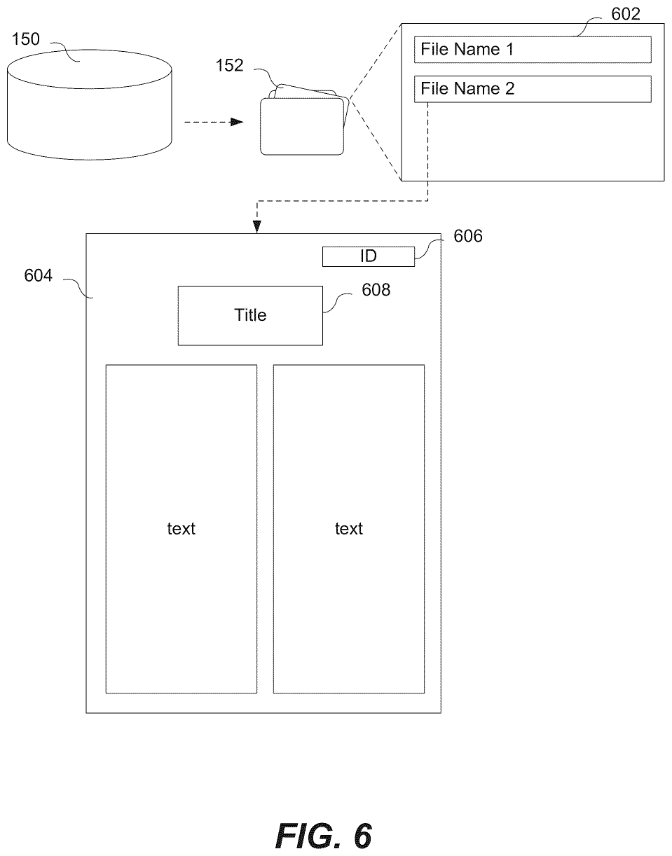

FIG. 6 shows a representation of document signatures. As previously described, the collection of documents 152 may be provided in a file structure and defined according to file names 602. The file name attributes of a given document may thus be determined from the file names 602. Each file name 602 corresponds to a given document, which is shown as document 604. The document 604 comprises a document identifier 606, and a title 608.

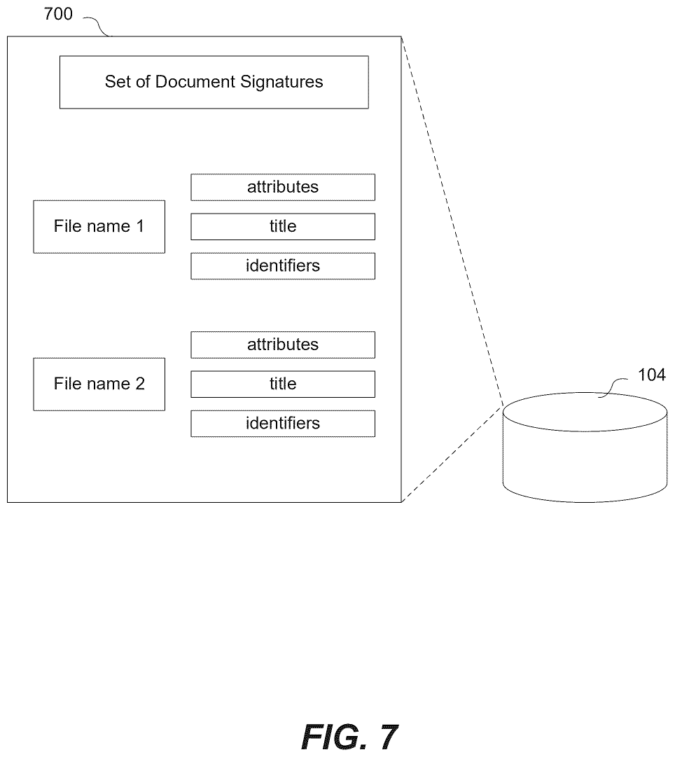

FIG. 7 shows a representation of a set of document signatures 700. The document signature generated at 410 in the method 400 may be stored as part of a set of document signatures (e.g. in the data storage 104 of FIG. 1). The data storage 104 may store a file with the document's file name as the key and the document signature as the value, where the document signature comprises one or more of file name attributes, a title of the document, and identifier(s) of the document. Accordingly, the set of document signatures facilitate comparison with the referenced document signatures.

As described with reference to FIG. 3, the method 300 comprises analyzing the collection of documents to identify a referenced document referred to within a document in the collection of documents (306).

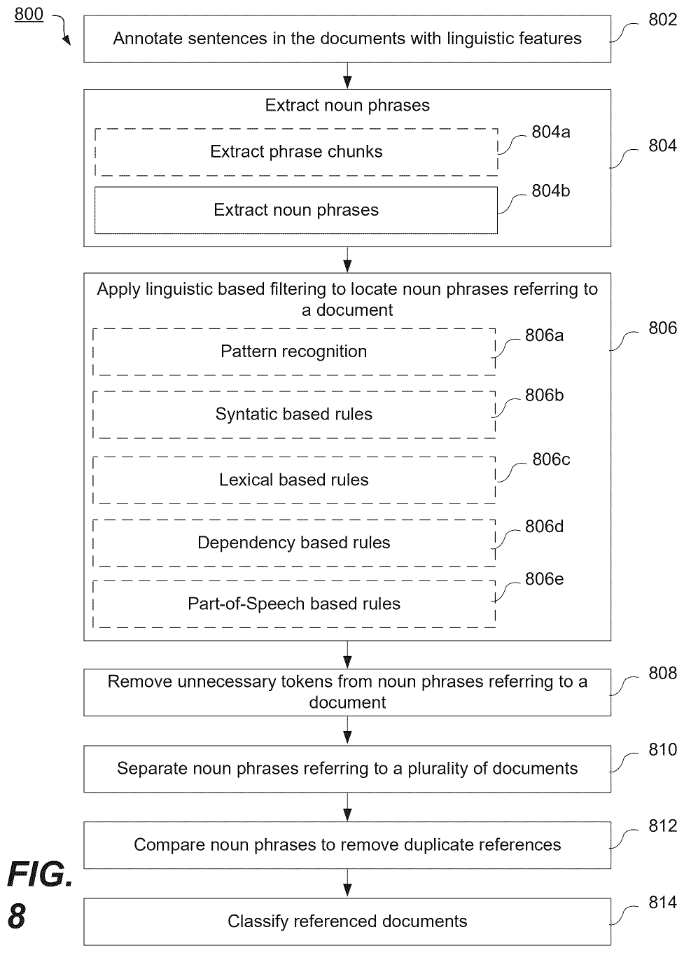

FIG. 8 shows a method 800 of analyzing a document to identify a referenced document referred to within said document. While the method 800 is described with respect to analyzing one document, it is to be understood that this method can be performed on each document in the collection of documents.

The method 800 of analyzing a document to identify a referenced document referred to within said document comprises tokenizing and annotating (802) sentences from the document with linguistic features; extracting (804) noun phrases from said annotated sentences; and applying (806) linguistic based filtering to locate noun phrases comprising the referenced document.

Annotating (802) sentences from the document with linguistic features may be performed using known natural language processing pipelines (NLP). Further, a person skilled in the art will appreciate that tokenization may be considered as part of the annotation process at 802 to facilitate annotations.

Once the language model is loaded, a language processing pipeline is initialized for all given text. This pipeline consists of various components specifically designed to process, analyze, and annotate the text. Through this language processing pipeline, each string of text goes through fundamental linguistic preprocessing, such as sentence segmentation and/or tokenization. Each sentence is split into individual tokens, and each token is assigned linguistic features (such as Part-of-speech tags, or POS-tags). Non-extensive natural language preprocessing techniques and linguistic features that may be used may include: Tokenization, Part-of-speech (POS) Tagging (Universal and/or Penn), Dependency Parsing, Lemmatization, Sentence Boundary Detection, Sentence Segmentation, Noun chunking, Noun Phrase extraction, Named Entity Recognition, Lemmatization.

In some implementations, method 800 may further comprise an additional linguistic preprocessing step. Indeed, sentences containing references are often longer and more complex than regular sentences that NLP processing pipelines are trained for. An example of a longer sentence is: “In accordance with the provisions of Section 525 of the Federal Food Drug and Cosmetic Act, and the Code of Federal Regulation 21 CFR 316.20 and 21 CFR 316.23, GENAIZ Subsidiary 2, ABC (GENAIZ) is requesting Orphan Drug Designation (ODD) for nicoracetam, a selective and reversible noncompetitive inhibitor.”

Longer sentences like the one showed above with ambiguous syntax and unknown tokens (such as “GENAIZ”) create inconsistent parsing, and thus inconsistent linguistic annotations. For example, prepositional phrases can be confused with nouns phrases: in the idiom “in line with”, “line” is extracted by regular NLP processing pipelines as a possible noun phrase. Punctuation in a reference could also be mistaken with the end of a sentence if an extra space is present: “CFR 316.20” and “CFR 316.20” therefore produce two different parse trees, when it is only one biomedical reference.

To correct these aberrant parses, the disconnected phrases of a parsed sentence are artificially glued to fix pattern errors when a punctuation token is mistaken for breakpoint.

The dependency structure of a sentence is typically represented in a tree-like structure, with the root being the main verb in a typical sentence. Parsing algorithms may be used to build a new dependency tree for each sentence. The new dependency tree has an improved understanding of the relationships between the words of a sentence. Each word is then connected to its head through dependency relationships. The syntax and the dependencies are thus clarified. This technique avoids retrieving prepositional phrases such as “in line with” as a noun phrase during extraction of noun phrases described below, as the system better understands that “line” is indeed part of a prepositional phrase.

Once this gluing is done and the new dependency trees are made, coreference resolution may also be performed so vague pronouns like “it” or “they” are replaced by their meaningful nouns.

In some embodiments, each token is annotated with the linguistic features obtained during the additional linguistic preprocessing step and also with the linguistic features obtained from the natural language processing pipeline (NLP) that haven't been fixed (like the lemma).

In some embodiments, method 800 may further comprise extracting phrase chunks (804a) that may contain a reference. This may be performed by analyzing the dependency tree of each sentence and identifying the root in each sentence, which is usually a verb. From there, the dependency tree for phrase chunks is explored, as the dependency tree allows to isolate groups of words that are related to each other. The subject, direct and indirect objects, modifiers (such as adverbial modifiers), which are dependencies of the identified root, are retrieved. Then, all types of dependents are extracted as phrase chunks.

Extracting noun phrases (804b) from said annotated sentences may in some instances be performed taking into account the extracted phrase chunks. Indeed, the phrase chunks may be filtered to retain the phrase chunks with a noun in them, making them noun phrases.

As an example, consider the sentence: “This audit was conducted in line with GEN Genetic Services policies”. The extraction 804 of a noun phrase from this sentence may include creating the following chunks: ‘This’, ‘This audit’, ‘This audit was GEN Genetic Services policies with line in conducted’, ‘GEN Genetic Services policies with line in’, ‘GEN Genetic Services policies with line’, ‘GEN Genetic Services policies with’, ‘GEN’, ‘Genetic’, ‘GEN Genetic Services’, ‘GEN Genetic Services policies’. Phrase chunks that are not directly adjacent to the head of the sentence or root are removed while paying attention to the order of the tokens. Duplicates and phrase chunks that are subsets of others are removed. The final result of the noun phrase extraction is: ‘This audit’, ‘GEN Genetic Services policies’.

In comparison, regular NLP pipelines may be returning one more noun phrase which is a false noun phrase (“line”), as it is part of the idiom “in line with”. This enhancement to phrase chunk extraction, and therefore to noun phrase extraction, avoids returning many false positives of references to the user.

In some embodiments, the length of noun phrases passed to the next block may be limited to k tokens, in order to remove long phrase chunks that probably do not contain references.

Applying (806) linguistic based filtering to locate noun phrases comprising the referenced document may comprise applying filters based on one or more of: pattern recognition (806a), syntactic based rules (806b), lexical based rules (806c), dependency based rules (806d), and part-of-speech based rules (806e).

A detailed discussion on example filters that may be used to locate noun phrases referring to a document is held below. Other filters may be used to the same effect. The example filters discussed herein may be used alone or in conjunction with each other. A combination of filters may be used as would be understood by the person skilled in the art. Using the filters in conjunction with each other improves identification of noun phrases referring to a document by minimizing the false negative and the false positive results. A person skilled in the art will appreciate that the number of filters as well as their nature and the rules of each filter are tunable.

In one embodiment, the filters are implemented as a set of rules. Part-of-speech based rules (806e) may be used to select noun phrases comprising proper nouns.

Indeed, references containing proper nouns and references containing common nouns are grammatically different as these types of nouns usually play different dependency roles in a sentence containing a reference. For example, a significant proper noun in a reference can be a simple “compound”, while a significant common noun in a reference is unlikely to be a compound but more a subject (having “nsubj” dependency tag for example) or an object (having “dobj” dependency tag for example). Thus, noun phrases containing at least a proper noun are separated from the remaining noun phrases, which therefore contain at least one common noun.

Part-of-speech based rules (806e) may additionally be used to select noun phrases comprising common nouns. In some embodiments, all relevant common nouns, identified with the POS-tag “NOUN” are kept for further processing.

Lexical based rules (806c) may also be used to filter in or identify noun phrases containing a reference. In some embodiments, lexical based rules may be leveraged to keep only noun phrases containing certain keywords denoting a reference this may be implemented using a reference keyword dictionary.

In one embodiment, the reference keyword dictionary may be made of two lists: “Words” and “Abbreviations”. The list named “Words” may comprise words such as “Pharmacopeia”, “policy”, etc. It will be appreciated that the keywords in the reference keyword dictionary are tunable and depend, amongst other things, on the field of implementation of the methods described herein.

Syntactic based rules (806b) may further be used in conjunction with the lexical based rules to filter in or identify noun phrases containing a reference. In the example noun phrase “The protocol departments”, “protocol” is normally representative of a reference but its syntactic and dependency roles do not demonstrate that “protocol” here is a reference. “Protocol” in the sentence above is a “noun” (from its POS-tag) with a dependency role named “compound”.

Using the lexical based rules in conjunction with the syntactic based rules allows to confirm that the noun phrases do actually refer to a document. For instance, the reference keyword dictionary of the lexical based rules shows the words that can be reference. The syntactic based rules allow to confirm the keywords based on their syntactic tags and/or dependency roles in a sentence.

Dependency based rules (806d) may further be used to identify noun phrases containing a reference. In this case, a list of acceptable dependency roles is made available for the method 800. The list is preferably tunable and may include “root” for example.

The Part-of-speech based rules (806e) may be used in conjunction with dependency based rules (806d). For example, only noun phrases with at least k′ proper nouns and playing certain dependency roles may be kept for further processing. In some embodiments, part-of-speech tags may be leveraged by the syntactic based rules.

As explained above, it may be beneficial to use a plurality of filters in conjunction of each other. An example of lexico-syntactic-dependency rule that may be used is: (a) All nouns POS-tagged “NOUN” present in the list of generic keywords “Words” (b) tagged with the specific dependency tag “root” (c) and with at least one token POS-tagged “NUM” in their noun phrase are accepted.

In one embodiment, only the noun phrases respecting one of several rules will be further processed.

In a more strict filtering, only the noun phrases respecting several, possibly all, of the rules will be further processed.

Pattern recognition (806a) may also be used to identify noun phrases containing a reference.

Pattern recognition may be used, for instance, to find out if a URL is present or not inside a sentence. Different rules may be created with regular expressions (e.g., “regex”) to identify URLs. An example of a rule to recognize URL is: (?P<url>https?:\/\/[\hat{ }\s]+).

In some embodiments, all sentences containing a URL are kept for further processing.

Pattern recognition may be used, for instance, to identify all alphanumeric references. As some references are only identified as series of number, implementing a filter to retrieve all alphanumeric references may be beneficial. Pattern recognition may be used to retrieve alphanumerical IDs, file names and file paths, etc.

For example, to retrieve the ID of document B referred at in a document A, one common pattern of identifiers is that they tend to incorporate the use of hyphens “-” (for example, “HJK-JK-98798-02”). Accordingly, a regular expression rule that may be applied is to identify strings that contain hyphens.

Similarly, an example of a regular expression to retrieve a file name is the following (as the end of a file is usually a file extension such as .docx, .pdf, etc.):

$$( [ a - zA - Z 0 - 9 \backslash s\_ @ \backslash - \hat{} ! \#\$ \% \& += \{ \} ( ) \text{\textbackslash [} \backslash ] . ] + ) \text{\textbackslash .} ( txt \vert docx \vert pdf \vert jpg \vert png ) \$ .$$

Here is another example of a regular expression for a file path:

$$( [ azAZ ] : ) ? {( V ? [ azAZ 09 \backslash s\_ @ \text{\textbackslash \textasciicircum} ! \#\$ \% \& += \{ \} \text{\textbackslash [} \backslash ] ] + )}^{*} ( \text{\textbackslash .} ( txt \vert docx \vert pdf \vert jpg \vert png ) ) \$ .$$

In some embodiments, method 800 may further comprise removing unnecessary tokens from noun phrases comprising the referenced document (808).

Removing unnecessary tokens (808) may comprise removing extra space from noun phrases. For instance, (“Protocol A”) would become (“Protocol A”). Removing unnecessary tokens (808) may also refer to removing tokens that are known to not be a reference. For example, the token “in accordance with” is not a reference per se and is therefore removed.

Removing unnecessary tokens (808) may be performed through a list of lexico-syntactic-dependency rules to avoid removing any information that could be crucial to the user.

An example of truncated filtering lexico-syntactic-dependency rule that could apply is: (a) If the noun phrase is more or equal to three tokens, (b) if the tokens “accordance with” are found at the first and second token position of the noun phrase, remove “accordance with” from the noun phrase and keep the rest of the noun phrase.

Another example could be (a) if the first token has a dependency tag “nummod” with a POS-tag “SYM”, (b) and that the second token has a dependency tag “PUNCT”, remove the first two tokens of the noun phrase and keep the rest of the noun phrase as a reference.

Other examples of removing unnecessary tokens (808) from noun phrases comprising the referenced document are discussed in accordance with FIG. 9 and are referred to as final cleaning, preliminary cleaning, hard cleaning, or simply cleaning. As will be further apparent from FIG. 9, removing unnecessary tokens (808) from noun phrases comprising the referenced document may be performed repeatedly throughout the steps of method 800.

The method 800 may further comprise separating noun phrases comprising a plurality of referenced documents (810). In FIG. 9, described below, this is referred to as enumeration filtering. The idea is that a noun phrase may contain more than one reference at a time.

In cases where only one reference per noun phrase should be returned to the user, noun phrases comprising a plurality of referenced documents are to be separated.

In this case, the enumeration cutter preferably splits enumerations of references while prevents a reference containing an enumeration from being erroneously split. For example, “the Internal Policy on Expanded Access and the Internal Policy on Employees Training” are two references that have to be separated. However, the following reference should not be separated even if it contains a conjunction: “Regulations (EC) No 1853/2003 of the European Parliament and of the Council of 22 Sep. 2003”.

Here again, a set of enumeration rules may be developed. The set of rules may use lexical, syntactic and dependency information, to separate, when needed, references from an enumeration.

The method 800 may further comprise comparing the noun phrases to remove duplicate references (812) as the same reference could have been retrieved more than once, sometimes in a more partial form. The resulting noun phrases are referred to as the reference noun phrases.

For example, the following noun phrases “SOP-1256 Quality Risk Management” and “SOP-1256” could have been extracted.

In some embodiments, comparing the noun phrases to remove duplicate references (812) is performed for all identified references from a same document. As one example, this may be performed by iterating over each reference and checks if it is a substring of any other reference, to finally only return the longest version of a reference. In the example above, the two possible references will then be merged in one, “SOP-1256 Quality Risk Management”.

A last cleaning step may be performed to remove all unnecessary information from this last version of a reference, in order to maximize the matching of the found reference with its document signature, as explained with respect to FIGS. 5 to 7.

The method 800 may further comprise classifying the referenced documents (814), which may be based on a relevancy measure and/or provenance of the referenced document. A method of classifying the referenced documents (814) is further discussed with respect to FIG. 10 below.

FIG. 9 shows an architecture for analyzing the collection of documents to identify a reference to a document, the reference being made within a document in the collection of documents. The architecture is shown to comprise three main branches, namely, a customized Open Information Extraction (OIE) branch 910, NLP (Natural Language processing) branch 920 and Alphanumeric branch 930. The NLP branch 920 is shown to comprise the academic reference sub-branch, the short reference sub-branch, the reference with abbreviations sub-branch, and the reference with URL sub-branch. A person skilled in the art will appreciate that in some embodiments, only a subset of branches may be used to locate referenced documents. In other embodiments, two or more branches or sub-branches may be combined to locate referenced documents.

In the architecture of FIG. 9, the documents are converted to a standard format as discussed with respect FIG. 3.

Once the document is in a standard document format, the strings are passed to the Alphanumeric branch 930. The strings are simultaneously also fed to a natural language processing pipeline to be transformed into sentences and annotated with linguistic features as explained with respect to FIG. 8.

The annotated sentences are passed to the OIE branch 910 and the NLP branch 920.

In some implementations, the Alphanumeric branch 930 returns alphanumeric references that are not based on natural language processing.

In other implementations, the Alphanumeric branch 930 returns alphanumeric references that are based on natural language processing.

After the three branches 910, 920, and 930 are completed (i.e., noun phrases from the document that comprise a reference are identified), a further step 940 is shown for removing duplicates (i.e., compare the noun phrases to remove duplicate references), which removes all duplicate references and partial redundant references. In this way, all duplicate references are filtered out to return only the clearest possible format of a reference. The reference is then input into a reference classifier that is further described with respect to FIG. 10.

With respect to the OIE branch 910, this branch may implement additional linguistic preprocessing for the extraction of phrase chunks as described with respect to FIG. 8. This branch mostly deals with longer noun phrases. A first part-of-speech rule based filter and a dependency rule based filter may be used to select proper nouns. A second part-of-speech rule based filter may be used to select common nouns. The rules of the first and second part-of-speech rule based filters may be different. The OIE branch may also implement the lexical based rules, the dependency based rules and the syntactic based rules as the ones discussed with respect to FIG. 8. A preliminary cleaning and an enumeration filtering such as the ones described with respect to method 800 may also be implemented by the OIE branch.

The OIE branch also performs a final cleaning method where unnecessary information is removed from the noun phrases to return only the minimal relevant information to the user. To do so, syntactic and dependency rules (POS-tags and dependency tags) are used to determine the essential components of the reference, as explained with respect to FIG. 8.

In some embodiments, small noun phrases that do not refer to a specific document (ex.: Protocol #: UNI-QA-786-02) may be removed. An example of a removed noun phrase may be “2, Protocol”. To this effect, rules using the available POS-tags and dependency tags were created. For example, to check if a noun phrase containing two tokens is useless when one of them is a reference keyword (using the reference keyword dictionary), the nature of the second token is verified. If the latter is an article (POS-tag “DET”), a punctuation sign (POS-tag “PUNCT” or “SYM”) or a simple space (POS-tag “SPACE”), the noun phrase may then be discarded. This allows to remove nouns phrases such as “a appendice”, “/appendice”, “protocol”, etc.

Now, the NLP branch 920 (i.e., Natural Language Processing branch) takes the output of the NLP pipeline and uses it directly for the following sub-branches: the academic references sub-branch, short references sub-branch, references with abbreviations sub-branch, and references with URL sub-branch. Each of these sub-branches is configured to identify a certain type of reference.

In some embodiments, all four sub-branches may be performed under the OIE branch. In other embodiments, only some sub-branches, e.g. the “short references” sub-branch, may be merged with the “OIE references” sub-branch.

The academic references sub-branch may be configured to recognize any academic reference of this type: Jemal A, Costantino J P et al. Early-stage breast carcinoma. N Engl J Med 1991; 654:121-165.

In some embodiments, three conditions must be met in order for a reference to be accepted into this sub-branch. The sentence must meet precise criteria of POS and dependency tags and after a cleaning step, it must also respect lexico-syntactic criteria, as well as length criteria. Once these two criteria are met, the selected sentences may be evaluated by a machine learning model which approves or rejects the possible academic references. The steps are detailed below.

Examples of POS-filtering and dependency rules that may be implemented to select appropriate proper nouns for the academic reference sub-branch include keeping strings with proper nouns (i.e., identified with the POS-tag “PROPN”) and playing a certain dependency role. Of course, a list of acceptable dependency roles may be created for this task and may include for example “root”.

The preliminary cleaning of the academic reference sub-branch may resemble the step of removing unnecessary tokens from noun phrases (808) referring to a document as discussed with respect to FIG. 8.

The lexico-syntactic rules implemented by the academic reference sub-branch may include that at least one number (an “integer”) in a string referring to an academic reference (e.g. “De Lyu et al., 2019”). Alternatively or additionally, a token with a POS-tag “PROPN” should be the first token of the string (e.g. “De Lyu et al., 2019”). The length of the string may also be used to make sure the string fits between n and m tokens, representative of an academic reference.

With respect to the machine learning model, a machine learning model may be trained to recognize an academic reference from a none-academic reference. The multi-label text categorization of a natural language processing pipeline may be used as main component to train the model.

In some embodiments, if a string input into the academic references model reaches a confidence threshold, it is considered a reference. The model may be configured to filter out any strings that do not reach the confidence threshold.

Now, the short references sub-branch may be configured to complete the extraction of complex references from the OIE branch. When the OIE branch is dedicated to the extraction of complex references, the references sub-branch completes it by extracting shorter references, sometimes missed by the OIE branch.

In some embodiments, the short references sub-branch is merged with the OIE branch and therefore the OIE references branch is able to identify short references.

Examples of extraction of noun phrases and lexico-syntactic-dependency rules have already been discussed with respect to FIG. 8, and it will thus be appreciated how to use or adapt the teachings from the discussion on FIG. 8 to the short reference sub-branch.

Hard cleaning I and enumeration filtering of FIG. 9, may implement the methods discussed with respect to FIG. 8.

Hard cleaning II may be performed in order to remove extra information or unnecessary references from the extracted references of the enumeration split step.

For example, if a noun phrase was, before the enumeration split, “the form and the attached Protocol HJK-9087-01”, the enumeration rules separated them in “the form” from “the attached Protocol HJK-9087-01”. However, “the form” is irrelevant because it doesn't refer to a form in particular. This last “Hard cleaning II” thus removes “the form” from the list of possible references to only return a clean “the attached Protocol HJK-9087-01”.

The abbreviations sub-branch may be implemented to recognize references containing an abbreviation, such as this type: “21 CFR 312.50 General Responsibilities of Sponsors”. Here, the abbreviation is “CFR” for “Code of Federal Regulations”.

Metalinguistic features given to references with abbreviations are sometimes different than the ones given to references that do not contain abbreviations. This is often caused by the NLP language model being unfamiliar with “obscure” abbreviations such as “CFR”, but also because the presence of abbreviations in a sentence sometimes results in a different syntactic structure (for ex., an abbreviation may appear in parentheses following the name of an organism, or can, like the example above, simply lacks syntactic meaning). For this reason, an additional branch was developed specifically for references containing abbreviations.

The abbreviations sub-branch may be placed under the OIE branch. However, abbreviations, by their different linguistic traits, may need to have a “special” treatment in this pipeline and therefore other filters may be used for the abbreviations sub-branch.

Examples of lexical filtering and analysis of the syntactic and dependency context have been described above. For the Abbreviations sub-branch, the lexical filtering may be performed with the list of keywords “Abbreviations”.

In the block abbreviations within a sentence-like environment, a noun chunk module of a natural language processing pipeline may be used to isolate the noun phrases containing an abbreviation. The noun phrases containing an abbreviation are then passed through more restrictive cleaning filters that further isolate the noun phrase to keep only their most minimal shape.

The cleaning filters may be similar to the ones explained with respect to FIG. 8. However, even if the cleaning filters follow the same POS and dependency principles, they are slightly adapted to fit the needs of the abbreviations. With adapted cleaning filters, any extra information is discarded and only the relevant and shortest noun phrase is kept. For example, the noun phrase “the GxP Regulations for Healthcare containing quality” may be reduced to “the GxP Regulations for Healthcare”.

In some embodiments, only noun phrases of k tokens or more are kept, in order to remove the less informative noun phrases.

With respect to the other abbreviations block, references containing abbreviations appear sometimes in a text under the form of a list: therefore, they live independently of any sentence.

In some embodiments, no cleaning is performed here, as the lack of a sentence-like environment is more likely to have parsing errors.

As multiple abbreviations can be found inside a same noun phrase, an enumeration filtering is performed as described with respect to FIG. 8.

In the careful cleaning block, all small noun phrases that do not contain an indication to a specific document (a specific document such as “CFR 312”), indicated by the absence of a dictionary keyword “Abbreviations” may be removed. An example of a removed noun phrase may be “other requirements”.

In some implementations, noun phrases are excluded based on length criteria.

In some implementations, a cleanup step similar to the final cleaning of the OIE references branch may be used.

With respect to the reference with URL sub-branch, patterns are used to identify a URL as described with respect to FIG. 8.

In the extraction of noun phrases block, the noun chunk module of the natural language processing pipeline may be used on all strings containing an URL to extract noun chunks with an URL. For example, “the Registration Center https://www.fda.gov/drugs/disposal-unused-medicines-what-you-should-know/drug-disposal-drug-take-back-locations” may be extracted.

In the cleaning block, all noun chunks are cleaned with rules similar to the rules presented under preliminary cleaning of the OIE branch in order to return minimal information to the user.

In some embodiments, punctuation signs sometimes mistaken as being part of the URL may be cleaned. To do so, a list of punctuation signs is stripped around the URL, for example “[ ]” in “https://www.fda.gov”.

The alphanumeric reference sub-branch of alphanumeric branch 930 uses patterns similar to the ones discussed with respect to FIG. 8 to identify alphanumeric references.

In some embodiments, the alphanumeric reference sub-branch may be merged with the “references with URL” sub-branch.

Referring again to the method shown in FIG. 8, as described above classifying the referenced documents at 814 may be performed based on a relevancy measure and/or provenance of the referenced document.

FIG. 10 discloses a method 1000 for classifying referenced documents. Classifying referenced documents may be performed once duplicate references have been removed. For example, the architecture disclosed in FIG. 9 returns a list of referenced documents and method 1000 allows to classify said referenced documents. In some embodiments, method 1000 may be performed for all located references. In other embodiments, method 1000 may be performed only for missing references (e.g. as discussed with respect to the reference comparison 220 step of FIG. 2).

Method 1000 comprises tokenizing (1002) the reference noun phrase (i.e., the noun phrase resulting from the process of step 812 in method 800). It will be appreciated that a language model and a tokenizer can be used at 1002. For example, bi-directional or unidirectional encoder representations from transformers may be used. As an example, a BERT (“Bi-Directional Encoder Representations from Transformers”) family of language models and tokenizers could be used, or equivalent types of language models and tokenizers.

Method 1000 comprises vectorising the tokens into embeddings (1004).

In some embodiments, the language model may be used to calculate embeddings. The language model is an embedder that captures contextualized word representations and is designed to generate embeddings of words. The transformers of language model may process the tokens in a bidirectional way, meaning that they check the tokens before and after to capture contextual information, and they output contextualized representations, also named “embeddings”, for each token. However, it will be appreciated that other embedders can be used at 1004.

Method 1000 further comprises classifying (1006) the vectorized reference noun phrase using an artificial intelligence algorithm.

In one example, a machine learning model called “reference classifier model” may be trained with a MLPClassifier algorithm (Multi-layer Perceptron classifier algorithm) to classify the vectorized reference noun phrase.

The “Reference classifier model” may be trained to classify the referenced document of the vectorized reference noun phrases into a plurality of categories. For instance, examples of said categories may include “Internal” (1008), “External” (1010), and “Irrelevant” (1012). The classified references are output (1014).

External references may for example refer to publicly available documents.

Internal references may for example refer to documents representing an asset for the company, and which are not publicly available. An example of internal reference may be “Protocol HG-74” or “UNI Notebook No UN01677”.

Irrelevant references may for example refer to generic or less relevant references found, such as “the protocol discussed previously”, that do not refer to a specific document in particular.

In some embodiments, instead of returning to the user irrelevant references, a reference is instead classified into the irrelevant category, and is still accessible to the user to consult.

In other words, with the artificial intelligence model, the system 100 is now able to decide by itself what is relevant and what is not, on top of differentiating what is publicly available or not.

For example, referring again to FIG. 3, when method 300 comprises generating an output (312), the output may comprise an indication of referenced documents that are not available in the collection of documents. In some embodiments, the output may further comprise the classification results and the confidence of the artificial intelligence model in the classification.

For instance, an example of output may be “SOP-1561 Quality Systems”, “Internal”.

It is to be understood that depending on the application, different outputs may be generated 312 using the system and methods described herein.

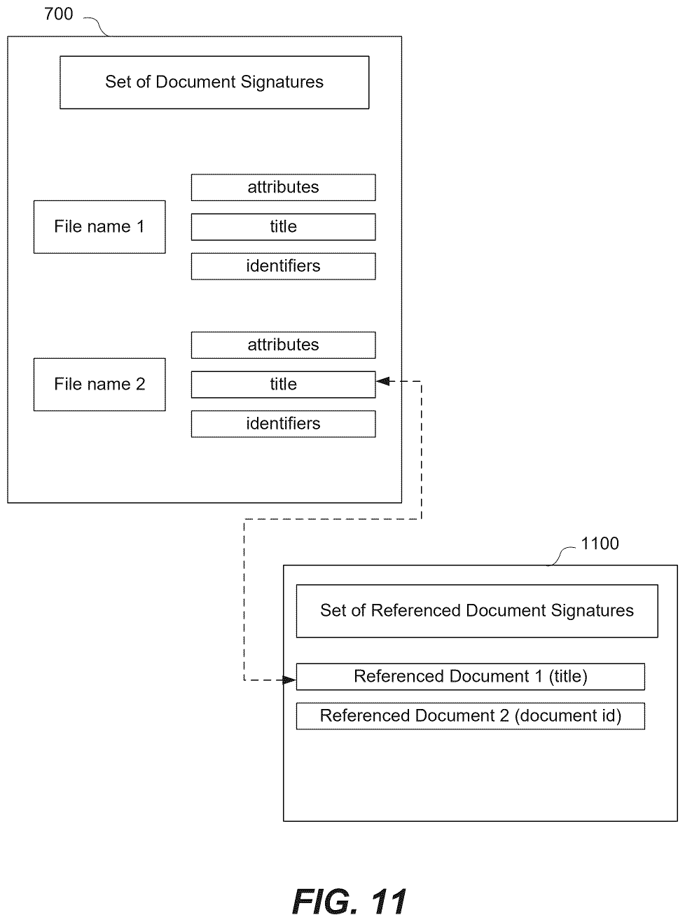

FIG. 11 shows a representation of comparing referenced document signatures against the set of document signatures. In FIG. 11, document identification and reference identification have been performed. Document identification allowed for the generation of a set of document signatures 700 in which each document signature comprises at least one of a file name attributes, title, and identifiers. Preferably, each document signature comprises file name attributes, a title, and an identifier of the document as this would help during matching referenced document signatures with document signature, however it will be appreciated that a document signature may comprise only one or more of file name attributes, a title, and an identifier of the document.

Reference identification allowed for the generation of a set of referenced document signatures 1100 in which each referenced document signature comprises at least one of a title, an identifier, or file name attributes.

The signature of referenced document 1 comprises a title. The document signature 2 has the same title. In consequence, when the referenced document signature 1 is compared against the set of document signatures, referenced document signature 1 would be matched to the document associated with document signature 2 and the referenced document 1 would be considered available in the collection of documents.

In accordance with the foregoing, it will thus be appreciated that one or more filters as described above can be applied to identify a referenced document anywhere in the text of a document. A referenced document signature is generated, and compared to document signatures to determine if the referenced document is within the collection of documents.

Referring back to FIG. 2, where a representation of a method 200 of assessing availability of documents referenced within a collection of documents is shown, in accordance with a second set of embodiments, the reference identification 210 may comprise identifying in-section references 212 and in-text references 214, as described below. According to an example embodiment, identifying the referenced document as an in-text reference comprises using pattern matching regular expressions to identify the referenced document within document data, and/or identifying text relations and/or any aspect of grammar to identify the referenced document within the text relations. It will be appreciated that the methods described in the second set of embodiments may also be combinable with the methods described above.

As described above, method 300 of FIG. 3 comprises analyzing the collection of documents to identify a referenced document referred to within a document in the collection of documents (306). Identifying a referenced document inside a document may comprise identifying the referenced document as an in-section reference, such as within a reference section of the document (e.g. “List of References”), or as an in-text reference, i.e. within free form text of the document, which may be identified using pattern matching and/or identifying text phrases.

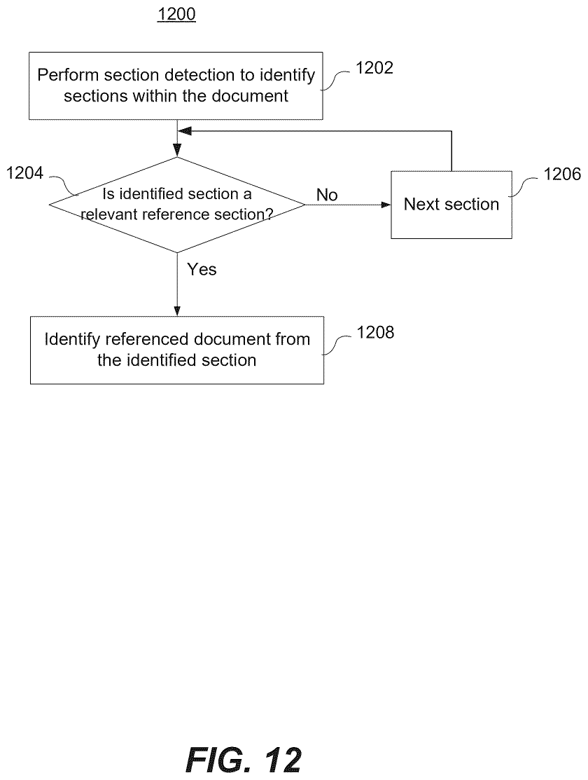

FIG. 12 shows a method 1200 of identifying a referenced document within a document. The method 1200 may be performed to identify the referenced document in the in-section reference 212.

Method 1200 comprises performing section detection to identify sections within the document (1202). A plurality of methods may be used to identify sections. For example, a section may be identified using detection of a least a line of space before keywords generally related to a section. In this instance, a section may further be identified by verifying when a paragraph starts and ends.

A determination is made if an identified section is a relevant reference section (1204). The determination may be performed by comparing titles of content of each section with a set of keywords such as appendix, reference, abstract, etc.

In cases where the identified section is not determined to be a relevant reference section (NO at 1204), the method 1200 moves to a next section identified within the document (1206), if available, and determines if the next identified section is a relevant reference section (1204).

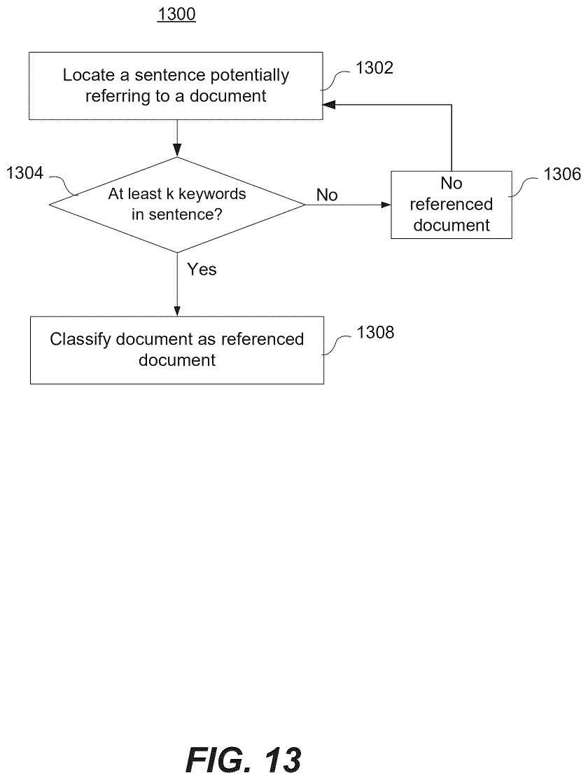

When the identified section is determined to be the relevant reference section (YES at 1204), the method 1200 comprises identifying the referenced document from the identified section (1208). Identifying the referenced document from the identified section is described in more detail in FIGS. 13 to 16.

It is to be noted that the methods described in FIGS. 13 to 16 may be performed for identifying an in-section reference or an in-text reference.

In some implementations, method 1300 of FIG. 13 may be performed for each sentence of each relevant section. For instance, this can be advantageous for in-section reference detection. However, in-section reference detection may require specific keywords to be added to the set of keywords discussed above. For instance, a reference section of a scientific paper typically presents reference documents in a list. In order to locate a sentence potentially referring to a document in such a reference section, the keywords may need to be updated to take this into consideration. Examples of keywords that may be used in this case may include: dates (as each scientific paper normally has a date of publication), university, et al., etc.

Method 1300 for identifying the referenced document can be seen as a filter that allows to filter in sentences potentially referring to a document based on a number k of keywords. However, if k is set too high, method 1300 may cause filtering out too many sentences and therefore, too many referenced documents may end up un-located (i.e., missing).

One filter may be based on Information extraction (IE) that refers to the process of turning unstructured natural language text into a structured representation in the form of relationship tuples. Each tuple consists of a set of arguments and a phrase that denotes a semantic relation between them. Open IE enables the diversification of knowledge domains and reduces the amount of manual labour. Open IE is known to not have a pre-defined limitation on target relations. Hence, Open IE extracts all types of relations found in a text regardless of domain knowledge, in the form of (ARG1, Relation, ARG2,) (this form is referred to here as (first argument, predicate, second argument)). This structure is near the metalinguistic structure of the language: From a semantic approach, a triple is a way to assign a property (rel) and data (seme) linked to this property (second argument) to a lexeme/word (First argument). In this way, a (semantic) trait is given to a word one linear relation at a time, allowing a word to be describe by one characteristic at a time, easily conceptualized later in a table. The extracted characteristics include contextual features, which are lacking in a more traditional non-pragmatic semantic approach.

FIG. 13 shows a method 1300 for identifying the referenced document in sentences. The method 1300 comprises identifying a sentence potentially referring to a document (1302). An instance of a sentence considered to be potentially referring to a document is a sentence that comprises a series of numbers (e.g., PD-3514). Hyphens may also be indicative of a sentence potentially referring to a document. A person skilled in the art will appreciate that depending on the field in which the disclosed invention is applied, the characteristics of a sentence considered to be potentially referring to a document may vary without departing from the scope of the disclosed invention.

Method 1300 further determines if the located sentence contains at least k keywords (1304). If the located sentence comprises less than k keywords (NO at 1304), it is determined that the located sentence does not contain the referenced document (1306), and the method continues with identifying another sentence (1302).

The keywords may be representative of words used in a sentence making a reference to a document. Examples of such keywords may include: refer, reference, appendix, URL, see, Annex, Agreement, Notebook, Patent, License, SOP, Schedule, Report, Records, Method, Audit, etc. In some implementations, the keywords may be domain specific or even company specific. In other implementations, the keywords may be obtained using a dictionary. Additionally or alternatively, the keywords may be series of numbers (e.g., PD-3514), hyphens, etc. Regex rules may also be set as part of the keywords.

A reference expression to retrieve an example of URL may be:

$$“ https ? : VV ( www \text{\textbackslash .} ) ? [ - a - zA - Z 0 - 9 @ : \% . \_ \text{\textbackslash +} ∼ \# = ] \{ 1 , 256 \} \text{\textbackslash .} [ a - zA - Z 0 - 9 ( ) ] \{ 1 , 6 \} \backslash b ( {[ - a - zA - Z 0 - 9 ( ) @ : \% \_ \text{\textbackslash +} . ∼ \# ? \& \backslash / \backslash / = ]}^{*} ) ”$$

A regular expression to retrieve an example of a Protocol ID may be: “TEC[0-9]{3}”

Parameter k (e.g., k=2) allows to set a threshold number of keywords that needs to be present in a located sentence for the located sentence to be considered as making reference to a referenced document. Parameter k can be set to be tunable hyperparameter.

When the located sentence comprises k or more keywords (YES at 1304), the method 1300 classifies the document referenced in the located sentence as the referenced document (1308).

In some implementations, method 1300 may be performed for each sentence of each document. That is to say, each sentence will be considered as potentially referring to a document at step 1302. For instance, this can be advantageous for in-text reference detection.

Method 1300 for identifying the referenced document can be seen as a filter that allows to filter out sentences potentially referring to a document based on a number k of keywords. However, if k is set too high, method 1300 may cause filtering out too many sentences potentially referring to a document and therefore, too many referenced documents may end up un-located (i.e., missing).

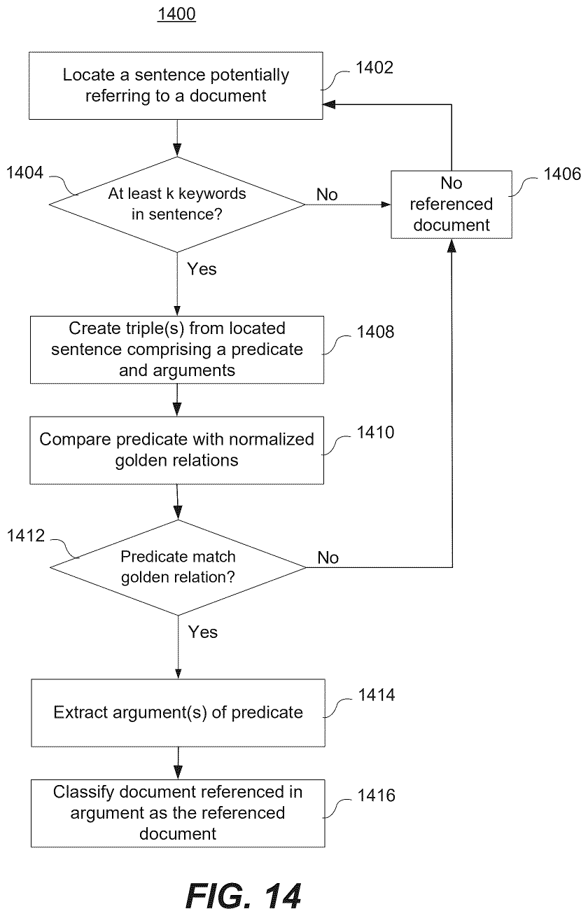

In some implementations, it may be preferable to use a plurality of filters in conjunction with each other rather than using one filter that may be too restrictive or too permissive. A second filter is described in relation with FIG. 14.

FIG. 14 shows a further method 1400 for identifying the referenced document that may be used in conjunction with method 1300. When method 1400 is used in conjunction with method 1300, method 1400 may be performed once the located sentence is determined to comprise k or more keywords, and steps 1402, 1404, and 1406 in the method 1400 are the same as steps 1302, 1304, and 1306 described with reference to the method 1300.

Method 1400 comprises, when it is determined that the located sentence comprises k or more keywords (YES at 1404), creating one or more triples from the located sentence comprising a predicate of the located sentence and at least one argument of the located sentence (1408), the at least one argument being any expression or syntactic element in the located sentence that serves to complete a meaning of the verb.

A triple may have the following form: (first argument, predicate, second argument). In some cases, no second argument can be found in the located sentence. In this case, the triple may have the form of: (first argument, predicate,“ ”).

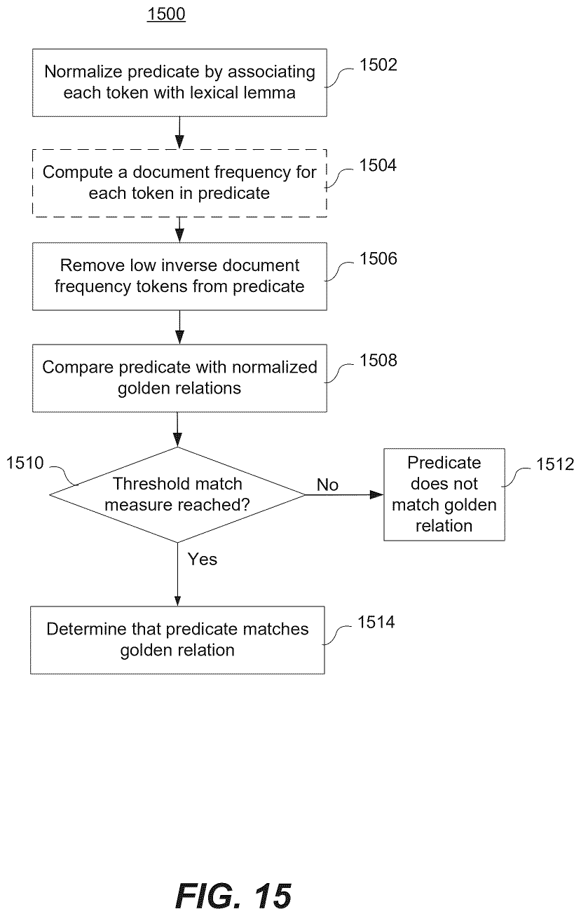

The method 1400 comprises comparing the predicate of the triple with one or more normalized golden relations (1410). FIG. 15 shows a method 1500 for comparing the predicate of the triple with one or more normalized golden relations and is discussed below.

A determination is made as to whether the predicate matches a golden relation (1412). When the predicate matches one or more normalized golden relations, one or more arguments of the predicate are extracted (1414) and the document referenced in the one or more arguments of the predicate is classified as the referenced document (1416).

When the predicate does not match one or more normalized golden relations, method 1400 determines that the located sentence does not contain the referenced document (1406). In such a case, method 1400 may return to 1402 to locate a next sentence potentially referring to a document.

It is to be understood that steps 1408 to 1416 of the method 1400 may be performed on each located sentence that contain at least k keywords. It is also to be understood that a located sentence may lead to more than one triple at 1408. In such a case, steps 1410 to 1416 may be performed for each triple.

In some implementations, method 1400 may be used without method 1300. In such implementations, method 1400 may start by identifying a sentence potentially referring to a document (1402). After identifying the sentence at 1402, method 1400 may proceed directly to creating triples from the located sentence (1408), and steps 1410 to 1416 are performed as explained above. When the predicate does not match one or more normalized golden relations (NO at 1412), method 1400 determines that the located sentence does not contain the referenced document (1406). In such a case, method 1400 may return to 1402 to locate a sentence potentially referring to a document.

FIG. 15 shows a method 1500 for comparing the predicate of the triple with one or more normalized golden relations. Method 1500 comprises normalizing the predicate by associating each token of the predicate with its lexical lemma (1502).

A token is an instance of a sequence of characters in a document that are grouped together as a useful semantic unit for processing. A person skilled in the art may already recognize that a lexical lemma may be seen as a particular form that is chosen by convention to represent a base word and that the base word may have a plurality of forms or inflections that have the same meaning thereof. In other words, the lexical lemma may be the canonical form, dictionary form, or citation form of a set of words.

In some embodiments, a list of tokens associated with high document frequency is provided and the method 1500, once the predicate is normalized (1502), proceeds to remove low inverse document frequency tokens (i.e., high document frequency tokens) from the predicate (1506). The token's document frequency is a measure that allows to measure the number of documents in which the token appears.

Examples of tokens associated with high document frequency may be articles and prepositions such as: “the”, “to”, “etc.”, “is”, “while”, etc.

In other embodiments, once the predicate is normalized (1502), method 1500 proceeds to compute, for each token or lemma of a predicate, a token's document frequency (1504). Following this, method 1500 removes low inverse document frequency tokens (i.e., high document frequency tokens) from the predicate (1506).

Once low inverse document frequency tokens are removed from the predicate at 1506, the predicate is compared with the one or more normalized golden relations (1508).

Golden relations are indicators of reference within a sentence. Typical examples of golden relations are: “As referred in”, “conducted against”, “may be verified in”, etc. Normalized golden relations are golden relations for which inflectional forms and derived forms of a common base form are removed. Normalized golden relations allow matching all verb tenses, for example, in a sentence. Two examples of normalized golden relations are:

$$“ accord / ( according ) [ VBG / ROOT ] to [ IN / prep ] is [ VBZ / auxpass ] mention / ( mentioned ) [ VBN / ROOT ] in [ IN / prep ] ”$$

A determination is made as to whether the predicate matches one or more normalized golden relations by determining if a threshold match measure is reached (1510). In practice, determining if the threshold match measure is reached can be seen as determining if the intersection between the predicate and the normalized golden relation contains more elements than a threshold number of elements (i.e., threshold match measure). The determination is shown below.

length [intersection (set (predicate), set (normalized golden relations))]≥threshold match measure

If the threshold match measure is not reached, then the predicate is determined to not match the normalized golden relation (1512). If the threshold match measure is reached, then the predicate is determined to match the normalized golden relation (1514).

The threshold match measure may be defined in a plurality of ways. An instance of a threshold match measure may be:

$$threshold match measure = para * minimum [ length ( predicate ) , length ( normalized golden relations ) ]$$

The parameter used in the definition of the threshold measure may be tuned by the user, and may be between 0.7-0.85 (e.g., para=0.75). In this way, the threshold match measure may be adaptive to the user's needs. The parameter may also be dependent on string-length, so setting it too high might be prohibitive, especially for long verb phrases with too much irrelevant tokens. In some instances, the parameter is a hyperparameter finetuned on an annotated dataset.

It is to be noted that method 1500 may be used on each predicate of each triple in each located sentence.

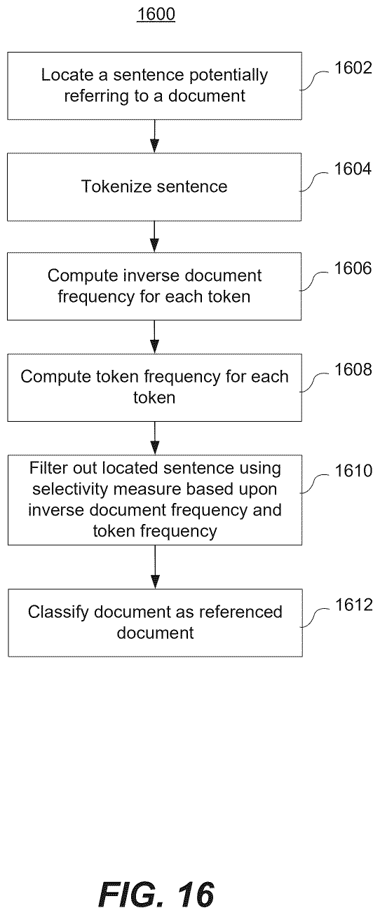

FIG. 16 shows a further method 1600 for identifying the referenced document using another example of filter. The methods/filters as described with respect to FIGS. 13, 14, 15, and 16 may be used separately or in any combination to identify a referenced document and the use of such methods individually or in various combinations are encompassed within the present disclosure.

When method 1600 for identifying the referenced document is used as stand alone filter, it begins with locating a sentence potentially referring to a document (1602). The method proceeds to tokenize the located sentence (1604), which may be performed in a similar manner as discussed with reference to tokenizing predicates in step 1502 in the method 1500.

An inverse document frequency is computed for each token (1606). The inverse document frequency for each token is computed from the token's document frequency. The token's document frequency is a measure that allows to measure the number of documents in which the token appears.

In some embodiments, instead of computing a document frequency for each token, a list of tokens associated with high document frequency is provided. In some instances, the list may also allow to retrieve the inverse document frequency for each token associated with high document frequency.

In both embodiments, the method 1600 also comprises computing a token frequency (i.e., term frequency) for each token (1608). The token frequency measures the number of appearances of a token in a given document.

The located sentence is filtered out (1610) based on a selectivity measure that takes into account token frequency (tf) and inverse token document frequency (idf). The selectivity measure can be seen as a numerical statistic that is intended to reflect importance of a word or token with respect to a document in the collection of documents.

The selectivity measure may for instance be a term frequency-inverse document frequency (tf-idf) as is known in the art of information retrieval. A person skilled in the art may appreciate that the term frequency-inverse document frequency is defined to increase proportionally to the number of times a token appears in the document and to be offset by the number of documents in the collection of documents that contain the token, which helps to adjust for the fact that some tokens appear more frequently in general.

Referring again to the method 1600, in instances where the selectivity measure is satisfied, the document referenced in the located sentence is classified as the referenced document (1612).

In some implementations, when method 1600 for identifying the referenced document is used in combination with method 1300 and/or method 1400, the method 1600 may be performed prior to classifying the document referenced in the located sentence as the referenced document at 1308, and prior to classifying the document referenced in the one or more arguments of the predicate as the referenced document at 1416, thus requiring all filters to be satisfied before classifying the document referenced in the located sentence as the referenced document.

A person skilled in the art will readily appreciate that the methods 1300, 1400, and 1600 may be combined in various combinations to provide various filters for identifying a referenced document. A method for identifying a referenced document referred to within a document may comprise one or more of the methods described herein.

It would be appreciated by one of ordinary skill in the art that the system and components shown in the figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

The embodiments have been described above with reference to flow, sequence, and block diagrams of methods, apparatuses, systems. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

It is contemplated that any part of any aspect or embodiment discussed in this specification can be implemented or combined with any part of any other aspect or embodiment discussed in this specification.

1. A method of assessing availability of documents referenced within a collection of documents, the method comprising:
analyzing the collection of documents to identify a referenced document referred to within a document in the collection of documents;
generating a referenced document signature for the referenced document; and
determining if the referenced document is available within the collection of documents by comparing a referenced document signature against a set of document signatures associated with the documents within the collection of documents.

2. The method of claim 1, further comprising:
creating the set of document signatures by generating, for each respective document within the collection, at least one unique document signature associated with the respective document.

3. The method of claim 2, wherein the at least one unique document signature associated with the respective document comprises one or more of: file name attributes, a title, and an identifier of the respective document.

4. The method of claim 3, wherein generating the at least one unique document signature of the respective document comprises determining the file name attributes using all tokens and numbers from a file name of the respective document.

5. The method of claim 3, wherein generating the at least one unique document signature of the respective document comprises determining at least one of the title and the identifier from data within the respective document.

6. The method of claim 1, wherein identifying a referenced document referred to within a document in the collection of documents comprises:
annotating sentences from the document with linguistic features;
extracting noun phrases from said annotated sentences; and
applying linguistic based filtering to locate noun phrases comprising the referenced document.

7. The method of claim 6, wherein applying linguistic based filtering to locate noun phrases comprising the referenced document comprises applying filters based on one or more of: pattern recognition, syntactic based rules, lexical based rules, dependency based rules, and part-of-speech based rules.

8. The method of claim 6, further comprising removing unnecessary tokens from noun phrases comprising the referenced document.

9. The method of claim 6, further comprising separating noun phrases comprising a plurality of referenced documents.

10. The method of claim 6, further comprising comparing the noun phrases to remove duplicate references.

11. The method of claim 1, wherein generating the referenced document signature for the referenced document comprises:
generating a set of referenced document signatures, wherein each referenced document signature comprises one or more of: file name attributes, a title, and an identifier of a corresponding referenced document;
comparing each generated referenced document signature in the set to identify any duplicate referenced document signatures, wherein two or more referenced document signatures are duplicate if one or more of the file name attributes, the title, and the identifier of the referenced document signatures are essentially identical; and
merging the file name attributes, the title, and the identifier from each of the two or more duplicate referenced document signatures to generate a unique referenced document signature of the referenced document.

12. The method of claim 1, further comprising:
converting respective documents in the collection of documents into a standard document having a standard document format, the standard document comprising data of the respective document, and the standard document format containing one or more annotations added to the data.

13. The method of claim 1, further comprising classifying the referenced document based on a relevancy measure and/or provenance of the referenced document.

14. The method of claim 13, further comprising generating an output based on a result of:
determining if the referenced document is available within the collection of documents; and
classifying the referenced document based on the relevancy measure and/or the provenance of the referenced document.

15. The method of claim 1, wherein when it is determined that the referenced document is not available within the collection of documents, the method further comprises generating an output indicating that the referenced document is not available.

16. The method of claim 1, further comprising generating an output based on a result of determining if the referenced document is available within the collection of documents.

17. The method of claim 1, comprising identifying a plurality of referenced documents within the collection of documents.

18. A method of identifying a document, comprising:
determining file name attributes using tokens and numbers from a file name of the document;
determining a title of the document;
searching for an identifier identifying the document; and
generating a unique document signature associated with the document, wherein the at least one unique document signature comprises one or more of the file name attributes, the title, and the identifier of the respective document.

19. A system for assessing availability of documents referenced within a collection of documents, the system comprising:
a client computer; and
an application server, comprising:
a processor; and
a non-transitory computer-readable memory storing computer-executable instructions, which when executed by the processor, configure the application server to:
analyze the collection of documents to identify a referenced document referred to within a document in the collection of documents;
generate a referenced document signature for the referenced document;
determine if the referenced document is available within the collection of documents by comparing a referenced document signature against a set of document signatures associated with the documents within the collection of documents; and
output a determination result to the client computer.

20. A non-transitory computer-readable memory having computer-executable instructions stored thereon, which when executed by a processor, configure the processor to:
analyze the collection of documents to identify a referenced document referred to within a document in the collection of documents;
generate a referenced document signature for the referenced document; and
determine if the referenced document is available within the collection of documents by comparing a referenced document signature against a set of document signatures associated with the documents within the collection of documents.
